(19) United States
(12) Patent Application Publication
(10) Pub. No.: US 2016/0041036 A1
(43) Pub. Date: Feb. 11, 2016

(54) METHOD OF NON-CONTACT CONTROL USING A POLARIZING PEN AND SYSTEM INCORPORATING SAME

(71) Applicant: OBSHESTVO S OGRANICHENNOJ OTVETSTVENNOSTYU "LABORATORIYA ELANDIS", Syktyvkar (RU)

(72) Inventor: Dmitry Aleksandrovich GERTNER, Syktyvkar (RU)

(21) Appl. No.: 14/921,262

(22) Filed: Oct. 23, 2015

Related U.S. Application Data
(63) Continuation of application No. PCT/RU2014/000270, filed on Apr. 14, 2014.

(30) Foreign Application Priority Data
Apr. 24, 2013 (RU) 2013119124

(51) Int. Cl. G01J 4/04; H04N 5/225; H04N 5/247; G06F 3/03; H04N 5/33

(52) U.S. Cl. CPC G01J 4/04; G06F 3/0304; H04N 5/33; H04N 5/247; H04N 5/2254; G02B 5/3025

(57) ABSTRACT

There are disclosed a method and a system for non-contact control in a form of a polarization marker, a receiving device, and a microprocessor. In the polarization marker, beams are polarized with a customized cylinder polarizer, pass through a system of lenses and reflectors and are emitted into space, wherein the direction of the polarization vectors is axially symmetrical about the virtual axis of the polarization marker. The receiving device located in the working plane identifies the direction and position in space of the polarization marker in relation to the receiver, the results being interpreted by the microprocessor into control commands The receiving device consists of polarimeters spaced at a predetermined distance. The polarimeters identify the direction of the polarization vectors of incident beams from the polarization marker. Based on the data obtained from each polarimeter, the microprocessor calculates the direction and angles of site of the polarization marker.

### CROSS-REFERENCE

The present application claims convention priority to Russian Utility Patent Application No. 2013119124, filed on Apr. 24, 2013, entitled [symbol] [symbol] [symbol] [symbol] [symbol] [symbol] [symbol] [symbol] . This application is incorporated by reference herein in its entirety. The present application is a continuation of International Patent Application no. PCT/RU2014/000270, filed on Apr. 14, 2014, entitled “METHOD FOR NON-CONTACT CONTROL WITH THE AID OF A POLARIZING PEN”. This application is incorporated by reference herein in its entirety.

### FIELD

The technology relates to the electro-optical industry, more specifically to the method and device for non-contact data control and input.

### BACKGROUND

There exist various methods and devices for remote data input in a form of so called presenters or markers. They are applied to implement an alternative method of data input into the PC and typically rely on habitual arm movements. There also exists a technology of video-based gesture recognition for non-contact control of software.

The downside of those presenters and markers for non-contact data control and input is their low positioning accuracy and large size of the devices themselves. The downside of the technology of video-based gesture recognition is a low positioning accuracy and a low response rate due to complexity of video data processing.

Russian patent application number 2012102208 discloses a method of non-contact control using a laser marker and a laser marker system for its implementation. This patent application discloses non-contact data control and input that consists of a laser marker and a receiver. The laser marker and the receiver cooperate to identify the spatial position of the laser marker relative to the receiver. The position is then analyzed and control commands are generated. The control commands can be for controlling a cursor on a monitor screen to which the receiver is operatively coupled. It is also possible to perform 3D positioning based on detection of the marker's spatial position relative to the receiver for the purpose of its use in computer games, simulators, graphic application, remote control of manipulators and devices, etc.

### SUMMARY

Inventors of the instant technology have appreciated at least one technical problem associated with the prior art solution. Taking the above-described solution (as disclosed in Russian patent application number 2012102208), some known solution suffer from a disadvantage of requiring an expensive receiver consisting of scores of photodetectors in a form of a frame fixed around the perimeter of the screen.

Other known implementations require complicated mechanisms for transformation of a laser beam into a plane with its further rotation. Another disadvantage of these prior art solutions is the use of mechanical components that in turn reduces the reliability of the device and increases the power consumption.

Embodiments of the present technology are directed to a device comprising a polarization marker and a receiver that are based on other optical processes, which allows making the device cheaper and more reliable due to elimination of mechanical components.

As such, in accordance with a first broad aspect of the present technology, there is provided a method for non-contact control using a system that includes a polarization marker and a receiver, the polarization marker consisting of a hollow cylinder polarizer, a light source the beams of which pass through the cylinder polarizer walls, reflectors and lenses; the receiver having a microprocessor and at least two polarimeters spaced at a predetermined distance about a perimeter of the receiver. The method comprises: causing the polarization marker to emit beams such that the direction of polarization vectors of beams radially is axially symmetrical about the virtual axis of the polarization marker, causing the receiver to receive the polarized light coming from the polarization marker, identifying, by the polarimeters, the direction of polarization vectors, based on the identified direction of polarization vectors, causing the microprocessor to calculate a direction and a position in space of the polarization marker in relation to the receiver, based on the direction and the position of the polarization marker, generating at least one control command

In accordance with another broad aspect of the present technology, there is provided a system for non-contact control. The system comprises: a polarization marker including a hollow cylinder polarizer having a wall, a light source for emitting a beam that passes through the wall of the hollow cylinder polarizer, reflectors and lenses arranged to emit the polarized beams to create a projection area in front of and around the polarization marker, a receiver consisting of at least two polarimeters spaced at a predetermined distance so as to identify the direction of polarization vectors of beams from the polarization marker, and a microprocessor connected to the receiver polarimeters.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a receiver of a system for non-contact control, the receiver being implemented in accordance with non-limiting embodiments of the present technology.

FIG. 2 depicts a portion of a polarization marker of the system for non-contact control of FIG. 1, the polarization marker being implemented in accordance with non-limiting embodiments of the present technology.

FIG. 3 is a schematic depiction of a direction of the polarization vectors that are axially symmetrical in a circle about a virtual axis of the polarization marker of FIG. 2.

FIG. 4 is a schematic depiction of beams emitted by a light source that are nominally split into two segments: a central segment located along the virtual axis of the polarization marker of FIG. 3

FIG. 5 depicts the polarization marker of FIG. 2 with a light source positioned within the polarization marker of FIG. 2, the light source being located at a rear of the polarization marker, as contemplated by some embodiments of the present technology.

FIG. 6 depicts two non-limiting implementations of a lens coupled to the transparent casing of the polarization marker of FIG. 2.

FIG. 7 depicts another embodiment of the polarization marker of FIG. 2 having an elongated negative conical torpedo-like len installed above the cylinder polarizer.

FIG. 8 depicts one non-limiting embodiment for implementing polarimeters as non-cooled bolometers.

FIG. 9 depicts another non-limiting embodiment for implementing polarimeters as a group of linearly polarized analyzers.

FIG. 10 depicts an embodiment of the system, having the receiver of FIG. 1 and the polarization marker of FIG. 2, the system having meniscus ‘fish-eye’ lenses coupled above the polarimeters of the receiver of FIG. 1.

### DETAILED DESCRIPTION OF NON-LIMITING EMBODIMENT(S)

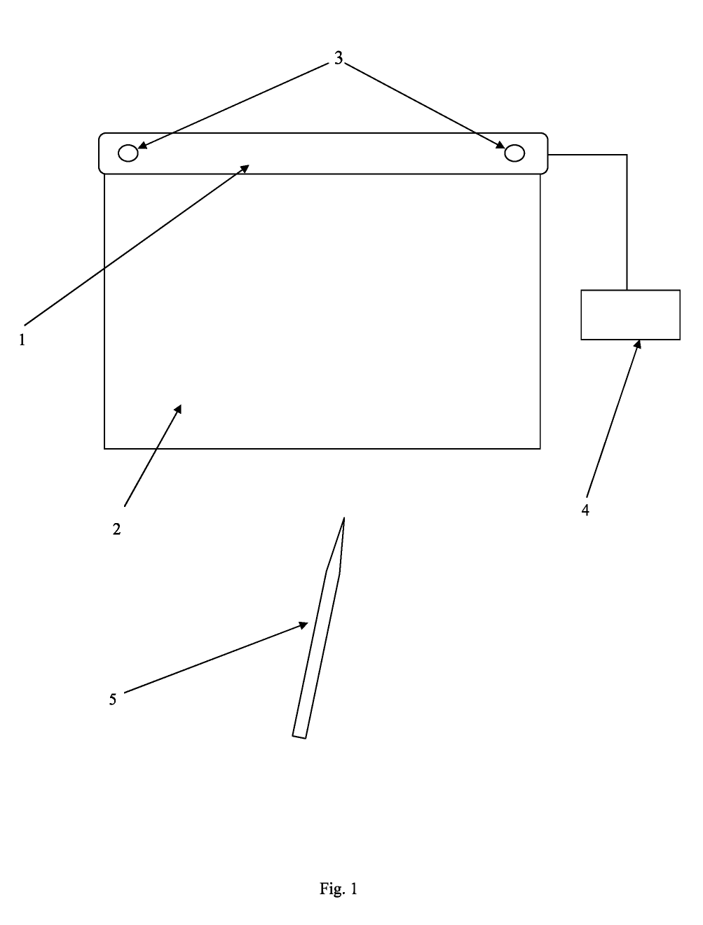

With reference to FIG. 1, in accordance with embodiments of the present technology, there is provided a receiver 1. Installed on the receiver 1 are polarimeters 3 connected to microprocessor 4 that is configured to process signals coming from the polarimeters 3. The polarimeters 3 can be located in a working plane 2 of a computer monitor or a TV-set, or a projection screen, or any other device.

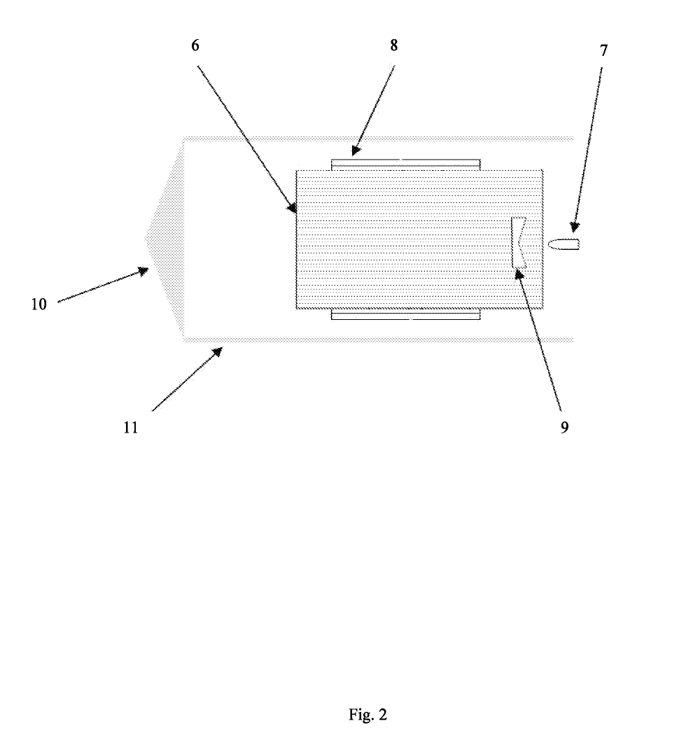

The signals are formed by light pulses coming from a polarization marker 5. The polarization marker 5 itself comprises a hollow cylinder polarizer 6 (see FIG. 2), a light source 7 for emitting in the infrared spectrum, a reflector 8, lenses 9 and 10, and a transparent casing 11. The receiver 1 and the polarization marker 5 can be considered to be part of a system for non-contact control that is provided in accordance with non-limiting embodiments of the present technology.

The hollow cylinder polarizer 6 can be made of a polymer polarizing film. The polymer polarizing film can comprise a pattern applied thereto, which pattern can be implemented as a diffraction pattern. In some non-limiting embodiments of the present technology, this pattern can include a triangular pattern. Naturally, in alternative embodiments, other shapes of the pattern can be used. An aluminum coating can be deposited by spraying on one edge of each ruling of the pattern. Such pattern on the polymer film with hundreds or thousands of rulings per millimeter has a polarizing effect in the infrared spectrum.

Additionally, this film can be bent while still maintaining its polarizing properties. In some embodiments of the present technology, in order to make the polarization marker 5 the film is rolled as a cylinder into a hollow tubular polarizer 6. When illuminated from the inside by the light source 7, a portion of the so-generated beams passes through the walls of cylindrical hollow polarizer 6 and such beams become polarized, wherein the direction of polarization vectors of radially emitted beams is axially symmetrical about a virtual axis (not depicted) of the polarization marker 5.

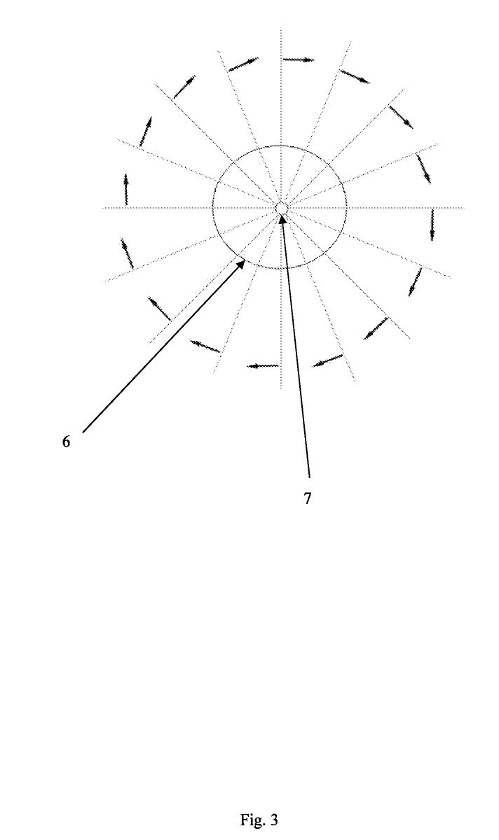

The pattern rulings can be arranged along the virtual axis or across it, around the cylinder. Depending on the direction of rulings on the cylinder, direction of the polarization vectors is axially symmetrical in a circle about the virtual axis of the polarization marker 5 (as is depicted in FIG. 3) or, alternatively, the polarization vectors lie in the planes traversing the virtual axis.

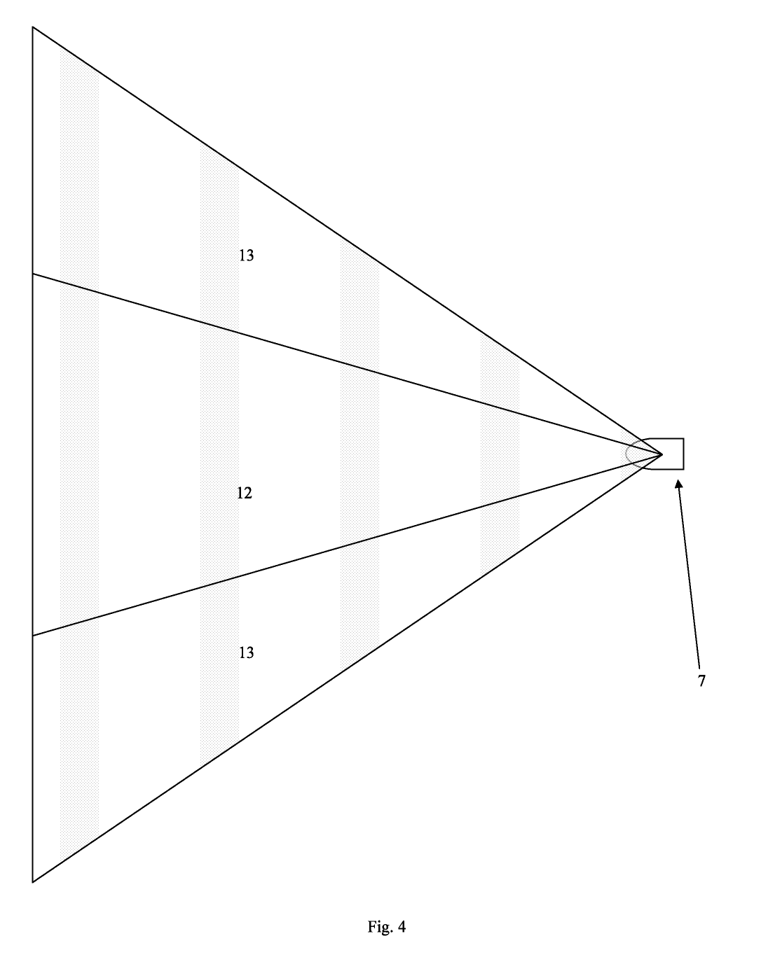

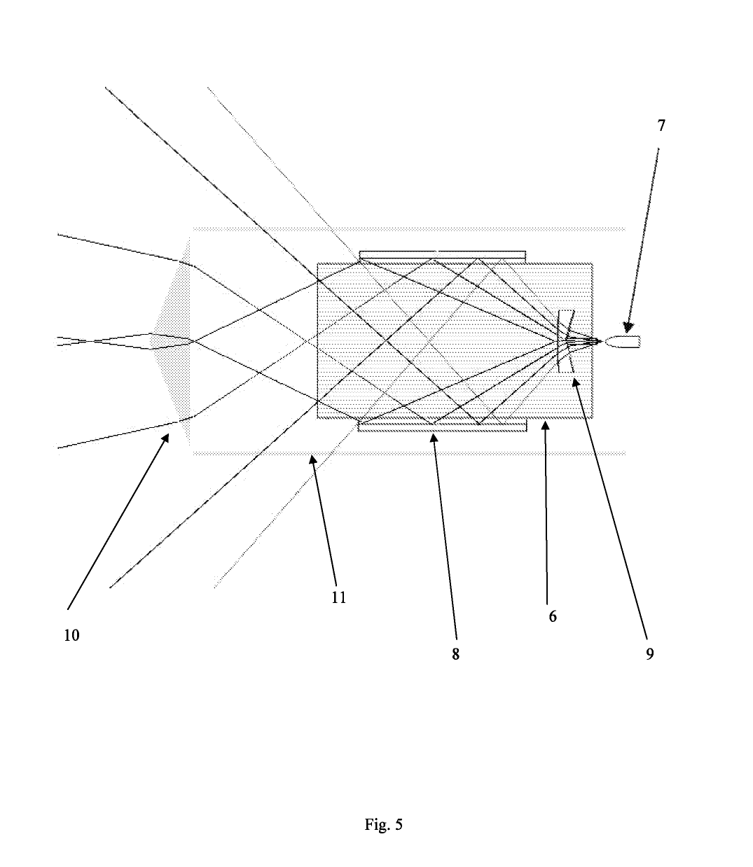

In order to ensure that the polarized beams are emitted towards the front of it covering (in addition to a radial direction relative to the polarization marker 5) while increasing the projection area, there can be provided an array of lenses and reflectors. To that end, beams emitted by the light source 7 (see FIG. 4) are nominally split into two segments: a central segment 12 located along the virtual axis of the cylinder polarizer under the aperture slope of about 30 degrees, and a side segment 13. Light source 7 (FIG. 5) is located at a rear of the hollow cylinder polarizer 6.

The light emitted by the light source 7 is directed towards a lens 9, which lens 9 can be implemented as a conical concave lens. The beam bundle of the central segment 12 is converted into a Bessel bundle, and the aperture slope for both segments is increased. Refracted beams are directed on the walls of the polarizer 6 onto which a cylindrical reflector 8 with a mirror-like inner surface is attached. Consequently, beams passing through the polarizer fall onto the cylindrical reflector 8 and are reflected in the direction of the front end of the polarization marker with a lens 10 attached thereto. The lens 10 can be implemented as a negative lens 10. The beams of the central segment 12 fall on the lens 10. This lens 10 can be implemented in a form of a conical convex lens. The lens 10 refracts beams in such a way so that the extreme beams intersect the virtual axis of cylinder polarizer 6, whereas the beams of the side segment are passed outside through transparent casing 11.

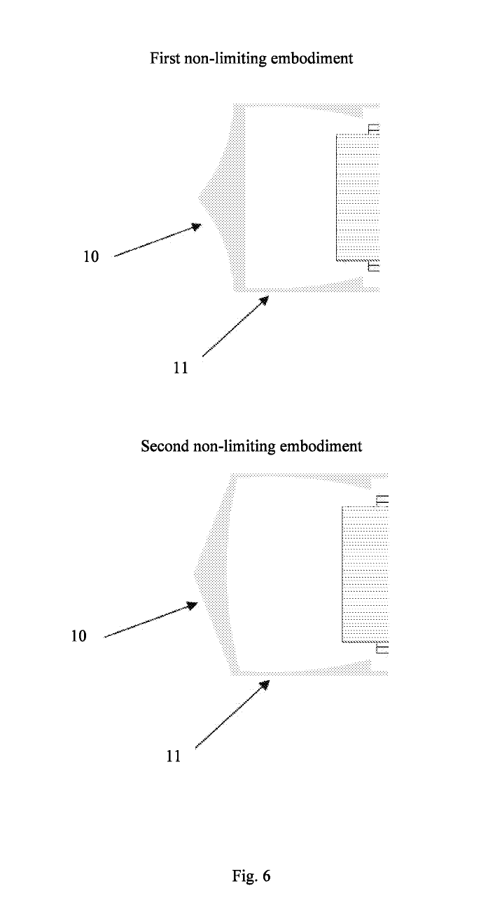

In order to increase the aperture slope of the emitted beams of both sectors and to reduce ‘blind zones’ between the adjacent beams of emitted beam bundles 12 and 13, the transparent casing 11 (see FIG. 6) can be implemented in a transversely-curved shape and the lens 10 can be made in a form of a flat-convex lens with a concave front conical face, as a first example of an implementation thereof In other implementations, a back face of the lens 10 can also be made concave, in which case the lens 10 is made in a form of a conical concave-convex lens.

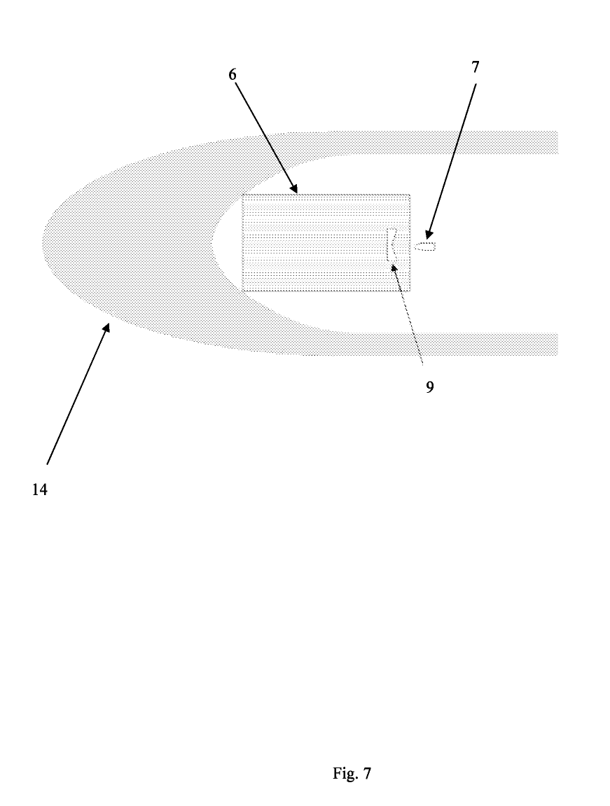

In other non-limiting embodiments of the present technology, beams that pass through the cylinder polarizer 6 are then refracted by an elongated negative conical torpedo-like lens 14 (see FIG. 7), installed above the cylinder polarizer 6. In this implementation, a cylindrical reflector can be omitted. To increase the aperture slope of beams coming from the concave conical lens 9, the flat face of the lens 14 can be made convex.

The polarization marker 5 can be used as a handling device operated by a user (not depicted). To interpret the motion of the polarization marker 5 into control commands, the direction and position of the polarization marker may need to be identified. To that end, there is provided the above-mentioned receiver 1 and the microprocessor 4 coupled thereto (or contained therein).

The receiver 1 comprises polarimeters 3 coupled to the working plane 2 and spaced at a predetermined distance around a perimeter thereof If a monitor is used as the working plane 2 (as an example), the polarimeters 3 can be placed around the perimeter of the monitor.

In some embodiments of the present technology, the polarimeters 3 comprise two instances thereof However, in alternative embodiments of the present technology, the polarimeters 3 can comprise at least two instances thereof.

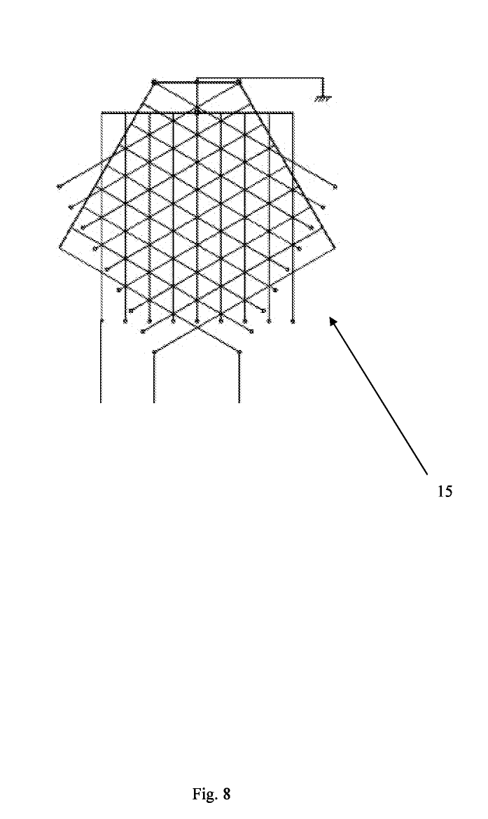

Non-cooled bolometers 15 (see FIG. 8) consisting of two, three or four crossed gratings may be used as polarimeters 3. The grating of each bolometer 15 consists of several parallel metal wires with a diameter of several microns. The wire can be made of nickel or platinum. The emitted light heats up the wires thus changing their electrical resistance. It is known that the direction of an electric vector of a linearly polarized incident wave in relation to the direction of the bolometer wire affects the change in its electrical resistance.

Therefore, by measuring the relevant changes in the electrical resistance in all gratings, one can calculate the polarization direction of incident light. When implementing the polarimeters 3, one can select the exact density of the gratings based on the premise that the more gratings there are in the polarimeter 3, the higher the measuring accuracy. Each bolometer grating is connected to a fast high-sensitivity analog to digital converter, which in its turn is connected to the microprocessor 4.

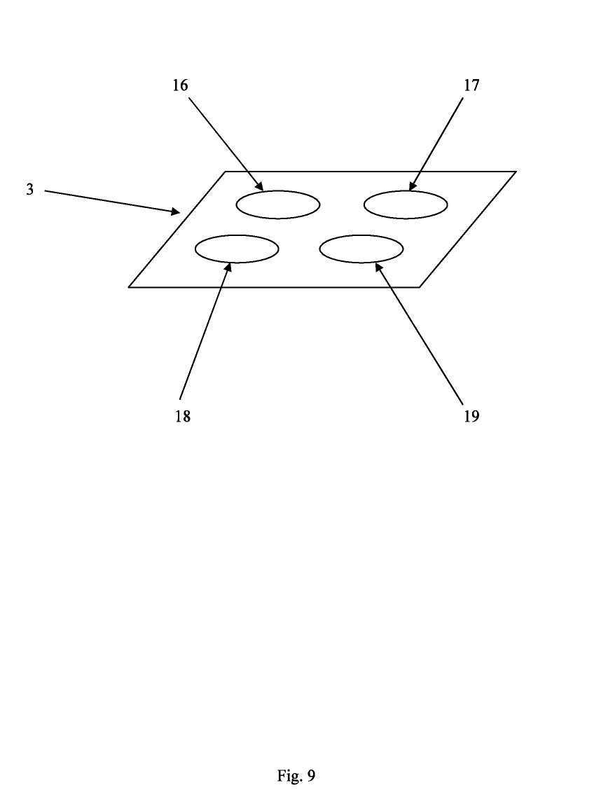

In other embodiments of the present technology, the polarimeters 3 can be made by using a group of linearly polarized analyzers. Each of the analyzers can be a dichroic linear polarizer. The analyzers are placed adjacent to each other, in one plane, with direction of linear polarization of each analyzer turned in relation to others, e.g. azimuth of the first analyzer 16 (FIG. 9) can be 0 degrees, azimuth of a second analyzer 17 can be 45 degrees, azimuth of a third analyzer 18 can be 90 degrees, and azimuth of a fourth analyzer 19 can be 135 degrees. A photodetector is placed under each analyzer. Each photodetector is connected to a fast high-sensitivity analog to digital converter that is connected to the microprocessor 4.

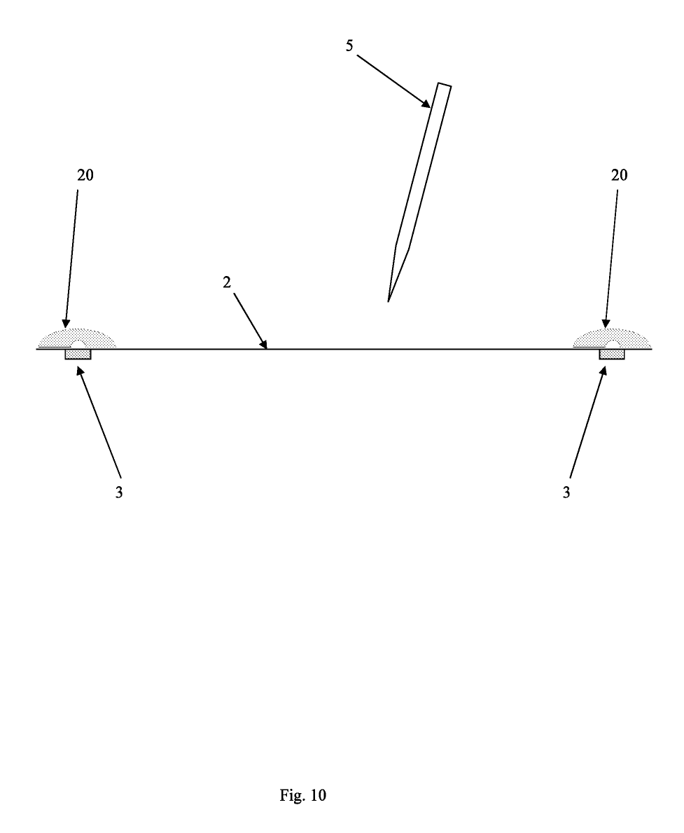

Additionally, light filters can be installed above the polarimeters 3 for transmission of a narrow spectrum of light emitted by the light source 7. In order that the polarimeters 3 can receive the light from the polarization marker 5 when it is located near the working plane, meniscus ‘fish-eye’ lenses 20 can be installed above the polarimeters 3 (see FIG. 10) in particular with a viewing angle of no less than 180 degrees. If the polarimeter 3 consists of a set of analyzers, meniscus lens 20 can be installed above each analyzer to eliminate any distortion caused by focusing or spot displacement.

In alternative embodiments of the present technology, at least two high-speed digital cameras, spaced at a certain distance and connected to the microprocessor 4, can be installed in the receiver 1. Meniscus ‘fish-eye’ lenses can also be installed above the digital cameras. Apart from meniscus lenses, additional lenses can be used for focusing the light.

Given the above-described architecture, a non-contact control method using polarization marker 5 can be implemented as follows. Source of light 7 is switched on inside the polarization marker 5 and starts emitting light pulses with a predetermined frequency. Infrared light emitted by the light source 7 passes through the walls of the hollow cylinder polarizer and a system of lenses, and reflectors in the polarization marker 5 as described above, and the exiting beams are linearly polarized.

The directions of the polarization vectors of the beams radially exiting the polarization marker 5 are axially symmetrical about the virtual axis of polarization marker 5. For the polarized beams to cover the area in front of the polarization marker, the beams from the light source 7 are passed through the hollow cylinder polarizer 6 with a portion of beams being refracted by the negative lens 10.

To control, the user then moves the polarization marker 5 in a space in front of the working plane 2 associated with the receiver 1. There are at least two polarimeters 3 spaced and fixed on sides of the receiver 1. Light from polarization marker 5 falls on polarimeters 3. Polarimeters 3 use a known method of differential measurement of the linear polarization. Polarimeters 3 are placed in such a way so that they allow determining the polarization direction along the working plane 2.

Signals from the polarimeters are sent to an analog to digital converter and then are sent to microprocessor 4 where final processing is performed. Light filters that pass a narrow spectrum of light emitted by the light source 7 and the frequency modulation of received signals by the known pulse frequency of light source 7 can be used in order to filter out any noise or interference.

Polarimeters 3 are used to locate the direction of polarization vectors in the working plane 2 and then using microprocessor 4 and the required software, virtual lines are drawn along the direction of vectors; their intersection is used to identify the intersection points of virtual lines in working plane 2 that shows the direction of polarization marker 5. Then, the resulting information is interpreted by the microprocessor 4 into one or more control commands.

If it is necessary to identify the angles of slope of the polarization marker 5 in relation to the working plane 5 for the purpose of control, more polarimeters 3 are installed in the receiver in orthogonal planes, e.g. additional polarimeters 3 are installed normal to the working plane 2. This will help to identify the angle of slope of the polarization marker 5 in relation to the working plane 2. As one will appreciate, latter embodiments are particularly useful when the polarization marker 5 is located near the working plane 2.

To identify an angle of slope of the polarization marker 5 when it is located at a distance from working plane 2 (but not necessarily limited to such embodiments), in addition to the polarimeters 3, two high-speed digital cameras can be coupled to the receiver near the polarimeters 3 and connect the cameras to microprocessor 4 via an analog to digital converter. These cameras are used to identify the space coordinates of light source 7 of the polarization marker 5 by using a phototriangulation method.

Having identified the coordinates of the point in the working plane 2, into which the polarization marker 5 is pointing, by using polarimeters 3 and having identified the space coordinates of light source 7 of the polarization marker 5 by using digital cameras, it is possible to calculate the angles of site of the polarization marker 5 in relation to the working plane 2.

In addition, having identified the space coordinates of the light source 7, it is possible to determine the distance from the polarization marker 5 to the working plane 2. To increase the viewing angle, digital cameras can be placed under meniscus ‘fish-eye’ lenses with a viewing angle of no less than 180 degrees. In polarization marker 5, an additional light source can be installed, its coordinates being detected by digital cameras, wherein the additional light source can emit light of a different spectrum and can be installed at the rear end of polarization marker 5. In case bolometers 15 are used as polarimeters, each digital camera 21 can be positioned under bolometer 15 and common meniscus lens 20.

Generally, the polarization marker 5 as described herein can be made by using an infrared semiconductor light diode, the hollow polarization cylinder can be made using a fluoroplastic substrate onto which rulings of the required pattern are applied by a photolithography method. For refraction and reflection of infrared beams, known materials for the infrared optics can be used, e.g. zinc selenide, etc. Optronics of the receiver is made on the basis of either semiconductor photodiodes and CCD matrices or using non-cooled grating bolometers, the grating of which can be made of micron-scale nickel wire. The microprocessor and the analog to digital converter can be made of existing hardware components that can be connected to a PC, for example, via USB. The polarization marker 5 can be powered by standard batteries or rechargeable batteries.

Accordingly, what is disclosed herein is a method and a system for non-contact control in a form of a polarization marker, a receiving device, and a microprocessor. In the polarization marker, beams are polarized with a customized cylinder polarizer, pass through a system of lenses and reflectors and are emitted into space, wherein the direction of the polarization vectors is axially symmetrical about the virtual axis of the polarization marker. The receiving device located in the working plane identifies the direction and position in space of the polarization marker in relation to the receiver, the results being interpreted by the microprocessor into control commands The receiving device consists of polarimeters spaced at a predetermined distance. The polarimeters identify the direction of the polarization vectors of incident beams from the polarization marker. Based on the data obtained from each polarimeter, the microprocessor calculates the direction and angles of site of the polarization marker. This system can be used for (but is not limited to):
controlling the cursor on a monitor screen by pointing the polarization marker at the monitor screen, wherein the receiver is installed on the monitor body and connected to a computer,
integrating into a remote control for intuitive and user-friendly content management in home theater systems or TV sets to which a receiver is connected,
navigating, in robotics, a robot in a room by installing receivers on the walls/ceilings and by installing a polarization marker on the robot body, with a wireless connection of the receivers to the robot,
3D positioning by recognizing the polarization marker position in space in relation to the receiver connected to a computer for use in computer games, simulators, graphics applications, for remote control of manipulators and devices.

Generally, a polarization marker can be made by using an infrared semiconductor light diode, the cylinder polarizer can be made using a fluoroplastic substrate onto which rulings of the required pattern are applied by a photolithography method. Polarimeters can be made using non-cooled grating bolometers.

1. A method for non-contact control using a system that includes a polarization marker and a receiver, the polarization marker having a hollow cylinder polarizer, a light source the beams of which pass through the cylinder polarizer walls, reflectors and lenses; the receiver having a microprocessor and at least two polarimeters spaced at a predetermined distance about a perimeter of the receiver; the method comprising:
causing the polarization marker to emit beams such that the direction of polarization vectors of beams radially is axially symmetrical about the virtual axis of the polarization marker,
causing the receiver to receive the polarized light coming from the polarization marker,
identifying, by the polarimeters, the direction of polarization vectors,
based on the identified direction of polarization vectors, causing the microprocessor to calculate a direction and a position in space of the polarization marker in relation to the receiver,
based on the direction and the position of the polarization marker, generating at least one control command.

2. The method of claim 1, wherein the polarization marker comprises a hollow cylinder polarizer, the beams from the light source are emitted from inside the hollow cylinder polarizer, wherein a part of exiting beams are refracted by a negative lens so as to cover an area in front of the polarization marker.

3. The method of claim 1, wherein the polarimeters in the receiver are installed in a working plane, and wherein
identifying, by the polarimeters, the direction of polarization vectors comprises:
identifying the direction of polarization vectors in the working plane; the
identifying further comprises:
drawing an intersection of two virtual lines along the obtained direction of polarization vectors in to identify the coordinates of the intersection point of the two virtual lines allowing determining of the direction of the polarization marker.

4. The method of claim 1, wherein the polarimeters on the receiver end are placed in different orthogonal planes, and wherein identifying, by the polarimeters, the direction of polarization vectors comprises: identifying the direction of polarization vectors in the different orthogonal planes.

5. The method of claim 1, wherein the light source emits pulses with a predetermined frequency that is used by the receiver to filter out noise.

6. The method of claim 1, wherein the receiver comprises at least two additional digital cameras coupled to the processor, the at least two additional digital cameras used to identify the coordinates of the light source in the polarization marker using a phototriangulation method, the method further comprises correlating the coordinates of the light source with the coordinates of a point in a working plane at which the polarization marker is pointed, whereby the angle of site of the polarization marker in relation to the working plane is calculated.

7. A system for non-contact control, the system comprising:
a polarization marker including a hollow cylinder polarizer having a wall, a light source for emitting a beam that passes through the wall of the hollow cylinder polarizer, reflectors and lenses arranged to emit the polarized beams to create a projection area in front of and around the polarization marker,
a receiver consisting of at least two polarimeters spaced at a predetermined distance so as to identify the direction of polarization vectors of beams from the polarization marker, and
a microprocessor connected to the receiver polarimeters.

8. The system of claim 7, wherein the light source comprises an infrared light diode.

9. The system of claim 7, wherein the hollow cylinder polarizer comprises a film grating polarizer rolled into a cylinder.

10. The system of claim 7, wherein the light source is located at a rear end of the hollow cylinder polarizer, and wherein the polarization marker further comprises a concave conical lens placed in front of the light source, while a reflector made in a form of a cylinder with a mirror-like inner surface is put on the hollow cylinder polarizer, and a negative lens is placed at the front end of the hollow cylinder polarizer.

11. The system of claim 10, wherein the negative lens at the front end of the hollow cylinder polarizer comprises a flat-convex lens with a concave conical face.

12. The system of claim 10, wherein the negative lens at the front end of the hollow cylinder polarizer comprises a conical concave-convex lens.

13. The system of claim 7, wherein the hollow cylinder polarizer further comprises an elongated conical torpedo-like negative lens.

14. The system of claim 7, wherein the polarimeters comprise non-cooled bolometers with crossed receiving gratings.

15. The system of claim 7, wherein polarimeters comprise a group of linearly polarized analyzers, located in one plane with their directions of polarization light transmission turned at a predetermined angle in relation to each other.

16. The system of claim 7, wherein the receiver further comprises meniscus ‘fish-eye’ lenses positioned above polarimeters.

17. The system of claim 7, wherein the receiver further comprises at least two high-speed digital cameras spaced at a predetermined distance and connected to the microprocessor.

18. The system of claim 17, wherein the receiver further comprises ‘fish-eye’ lenses positioned above digital cameras.

19. The system of claim 7, wherein the projection areas is maximized.
